(19) United States
(12) Patent Application Publication
(10) Pub. No.: US 2020/0166907 A1
(43) Pub. Date: May 28, 2020

(54) PROCESS FOR CUSTOMIZED WALL AND SURFACE REPAIR PATCHES

(71) Applicant: Amy Louise FREDERICK, Madison, WI (US)

(72) Inventor: Amy Louise FREDERICK, Madison, WI (US)

(21) Appl. No.: 16/638,360

(22) PCT Filed: Aug. 13, 2018
(86) PCT No.: PCT/US2018/046461

§ 371 Date: Feb. 11, 2020

Related U.S. Application Data
(60) Provisional application No. 62/544,890, filed on Aug. 13, 2017.

(51) Int. Cl. G05B 19/4099; B29C 64/386; B33Y 50/00; B29C 73/10

(52) U.S. Cl. CPC G05B 19/4099; B29C 64/386; G05B 2219/49007; B29C 73/10; G05B 2219/35134; B33Y 50/00

(57) ABSTRACT

Disclosed herein are methods and systems for preparing customized wall and surface repair patches. The methods and systems utilize surface and/or image data to prepare 3D models for repair patches unique to the particular damage by analyzing the surface or image data to generate a 3D model that a user can evaluate or augment before generating instructions for producing the repair patch.

### CROSS-REFERENCE TO RELATED APPLICATIONS

This application claims benefit of priority to U.S. Provisional Patent Ser. No. 62/544,890, filed Aug. 13, 2017, which is incorporated by reference in its entirety.

### FIELD OF INVENTION

### The present technology is generally directed to processes for repairing wall and surface damage.

### BACKGROUND

Many of the wall and surface patch methods used today depend on the applicators skill in applying plaster or other materials to fill the damaged area and/or on their skill in sanding the plastered surface or in creating the appropriate surface texture to provide a repair customized to the damaged area and surrounding surfaces. Alternatively, premade patches that are substantially planar do not fill the space of the damaged area and simply rests above the damage, resulting in an inferior repair that may be conspicuous and poorly matched to the wall or surface and may reduce the structural integrity of the wall or surface. Planar patches tend to be ill suited to damaged areas that are not flat such as damage in decorative plaster shapes or damaged areas that span surfaces with different dimensions. Moreover damage may occur to items made of a multitude of different materials and it may be hard to find a repair kit or materials that are suited to the surface that is damaged. Thus, there exists a need for a system to create a customize patch to fix damaged areas or any shape, size, and/or material that does not require specialized skills to create an inconspicuous and structurally appropriate patch.

### BRIEF SUMMARY OF THE INVENTION

Disclosed herein are methods and systems for preparing customized wall and surface repair patches. The methods and systems utilize surface and/or image data to prepare 3D models for repair patches unique to the particular damage by analyzing the surface or image data to generate a 3D model that a user can evaluate or augment before generating instructions for producing the repair patch.

In one implementation, the method for the production of a repair patch comprises receiving, at a backend system, surface data of a damaged surface imaged by an imaging device from a user device; generating, by the backend system, a 3D model of a repair patch from the surface data; and transmitting the 3D model from the backend system to the user device. In some implementations, the method further comprises receiving, at the backend system optional features selected by a user and generating, by the backend system, the 3D model of a repair patch from the surface data and the optional features selected by the user. In some implementations, the method further comprises generating, by the backend system, instructions for producing the repair patch corresponding to the 3D model. In some implementations, the method further comprises producing the repair patch from the instructions. In some implementations, the method further comprises receiving, at the backend system, additional surface data of the damaged surface and/or optional features selected by a user and generating, by the backend system, an updated 3D model of the repair patch. In some implementations, the method further comprises generating, by the backend system, instructions for producing the repair patch corresponding to the updated 3D model.

In another implementation, the method for the production of a repair patch comprises transmitting, from a user device to a backend system, surface data of a damage surface imaged by an imaging device; receiving, from a backend system, a 3D model of a repair patch generated by the backend system from the surface data; and transmitting, from the user device to a display device, the 3D model of the repair patch for evaluation. In some implementations, the method further comprises transmitting, from a user device to a backend system, optional features selected by a user and receiving, from the backend system, the 3D model of a repair patch generated by the backend system from the surface data and the optional features selected by the user. In some implementations, the method further comprises receiving, from the backend system, instructions for producing the repair patch corresponding to the 3D model. In some implementations, the method further comprises producing the repair patch from the instructions. In some implementations, the method further comprises transmitting, from a user device to a backend system, additional surface data of the damaged surface and/or optional features selected by a user and receiving, from the backend system, an updated 3D model of the repair patch. In some implementations, the method further comprises receiving, from the backend system, instructions for producing the repair patch corresponding to the updated 3D model.

In another implementation, the method for the production of a repair patch comprises receiving instructions for producing the repair patch corresponding to a 3D model matched to a damaged surface; and producing the repair patch from the instructions. In some implementations, the instructions are received at a 3D printer. The method may further comprises producing the repair patch by an additive manufacturing technique or a subtractive manufacturing technique. In certain implementations, the method may further comprise receiving delivery instructions from a use and/or delivering the repair patch to the user. In certain implementations, the method further comprises receiving payment from a user.

The methods described herein may be implemented on their own or in concert with any other method described herein. The methods may be performed with any of the systems or components described herein.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 is a schematic view of an exemplary system for preparing customized wall or repair patches.

FIG. 2 is a flowchart of one exemplary method for preparing customized wall or repair patches.

FIG. 3A illustrates a view of a damaged surface to be repaired.

FIG. 3B illustrates the virtual overlay of the damaged surface of FIG. 3A and an undamaged surface of FIG. 3A.

FIG. 3C illustrates a 3D model of a repair patch generated from surface data of the damaged surface of FIG. 3A.

FIG. 3D illustrates the damaged surface to be repaired of FIG. 3A along the cross-section 208.

FIG. 3E illustrates the virtual overlay of the damaged surface of FIG. 3A and an undamaged surface of FIG. 3A along the cross-section 208.

FIG. 3F illustrates a 3D model of a repair patch generated from surface data of the damaged surface of FIG. 3A. along cross-section 208.

FIG. 4 is a schematic view of exemplary operations performed from the system for preparing customized wall or surface repair patches.

### DETAILED DESCRIPTION OF THE INVENTION

The disclosed technology is directed to methods and systems for preparing customized wall and surface repair patches. The methods and systems utilize image data to prepare three-dimensional (3D) models for repair patches that are unique for the particular damage. The models may be further customized by user selected options prior to the manufacture of the repair patches. The present technology allows for customized repair patches that precisely fit or match to damaged areas of any shape, size, or material

Mobile phones, cameras, video recorders, and 3D scanners are useful in the process of creating 3D printed customized repair patches for damaged or broken items. A “repair patch”, which may be prepared according the methods and systems described herein, is intended to mean any replacement component capable of augmenting a surface to be repaired to provide a surface substantially similar in visual appearance and/or continuity to the surface in its prior undamaged state. A “surface to be repaired” or “damaged surface” is intended to mean any surface or object that may be repaired by augmenting the surface by filling a void, such as a scratch, a crack, a dent, an indentation, a hole, or a depression, or by replacing a portion of an object that has been removed or broken off. In some implementations, the surface is a wall, such as a structural wall in a building composed of any suitable building material. Examples of building materials include, but are not limited to, drywall, wood, cladding, siding, brick, cinderblock, stone, or metal. In other implementations, the surface is a surface of an object, such as an ear of a statue that has fallen off, a heel of a shoe that has fallen off, or a piece of ceramic dinnerware that has broken off.

Surface data, such as image data, spatial data, or any other type of data related to the damaged surface or user preference data may be received from suitable imaging devices capable of collecting data related to the damaged surface. The surface data may be analyzed in a number of different ways to determine a 3D model representing a repair patch. A 3D model is intended to mean a 3D virtual representation of the repair patch. Exemplary 3D models include, but are not limited to, a voxelized volume, a polygon mesh (or more simply “mesh”), or any other suitable representation of the volume and surface of an object to define the object's shape. The 3D model may further comprise additional information, including, but not limited to, color information, texture information, material composition, or any other additional information that may be used to produce the repair patch from the 3D model. The 3D model may be generated by analyzing the surface data to, for example, identify the damage to be repaired. The damage to be repaired may be identified in a number of different ways, including identifying the damage to be repaired or its features, differences between a damaged surface and an undamaged surface, determining textures of the surrounding undamaged surface or identical object, and the features of the environment. The 3D model of the patch may be generated and provided to the user via a display device for evaluation. The user can confirm that the model is acceptable or have the model revised. In some implementations, the 3D model may be provided in an augmented reality environment, presenting a 3D virtual representation of the specific repair patch that may be overlaid onto the damaged surface of the object and in the object's environment. The user may select to augment the model—for example by adjusting the color of the model or the texture or finish. The 3D model or instructions for producing a repair patch corresponding to the 3D model may than be supplied to the user, a third party, or to a 3D Printer so that a 3D repair patch may be produced by any additive or subtractive manufacturing technique, i.e., any 3D printing process, via a suitable device.

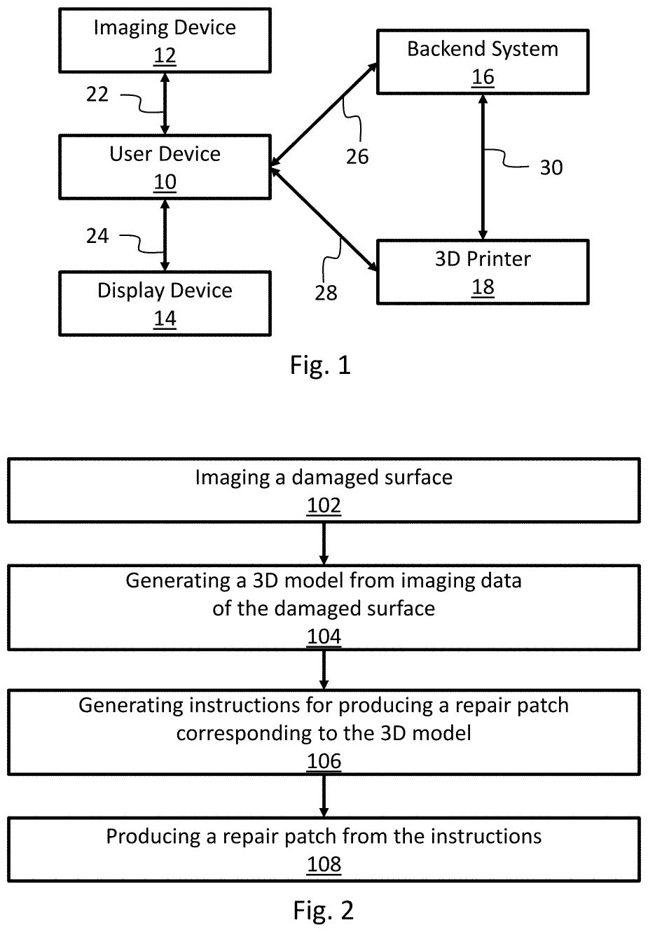

Referring to FIG. 1, a system for preparing a customized wall or surface repair patch includes a user device 10 associated with a user (not shown). The user device 10 is in communication 22 with and imaging device 12, communication 24 with a display device 14, and communication 26 with a backend system 16. The user device 10 may optionally be in communication 28 with a 3D printer 18. In certain implementations, the backend system 16 is in communication 30 with the 3D printer 18. The user device 10 and the backend system 16 may both be in communication with the 3D printer 18. In other implementations either one of the user device 10 or the backend system 16 is in communication with the 3D printer 18.

The user device 10 may be any computing device capable coordinating communications between the imaging device 12, the display device 14, and the backend system 16. In some implementations, the user device 10 is capable of communicating with a 3D printer 18. User devices 10 include computing devices in any form, including but not limited to, mobile computing devices, such as laptops, tablets, smart phones, and wearable computing devices (e.g., headsets and/or watches); stationary computing devices, such as desktops, workstations, servers, blade servers, or mainframes; or other appropriate computers. The user device 10 is in communication with an imaging device 12, a display device 14, a backend system 16, and, optionally, a 3D printer 18. In some implementations, the user device 10 is also capable of performing one or more operations associated with the methods described herein or comprises one or more applications associated with the methods described herein. Being in communication is intended to mean that the components are able to transmit and/or receive a machine-readable signal. The machine-readable signal may be transmitted and/or received wirelessly. In other implementations the machine-readable signal may be transmitted and/or received via wired connections. The user device 10 may communicate with any component via a network. This includes various types of networks, such as a local area network (LAN), wide area network (WAN), and/or the Internet.

Network may represent a long range network (e.g., Internet or WAN), in some implementations, or a shorter range network, such as a local area network (LAN). In some implementations, the network uses standard communications technologies and/or protocols. Thus, the network can include links using technologies, such as Ethernet, Wireless Fidelity (WiFi) (e.g., 802.11), worldwide interoperability for microwave access (WiMAX), 3G, 4G, Long Term Evolution (LTE), digital subscriber line (DSL), asynchronous transfer mode (ATM), InfiniBand, PCI Express Advanced Switching, etc. Similarly, the networking protocols used on the network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network can be represented using technologies and/or formats including the hypertext markup language (HTML or HTMLS), the extensible markup language (XML), etc. In addition, all or some of the links can be encrypted using conventional encryption technologies, such as secure sockets layer (SSL), transport layer security (TLS), virtual private networks (VPNs), Internet Protocol security (IPsec), etc. In other examples, the network can use custom and/or dedicated data communications technologies instead of, or in addition to, the ones described above. In some implementations, the user device 10 executes a Wi-Fi application that initiates communications with a recognized access point to establish wireless communication with the imaging device 12, the display device 14, the backend system 16, the 3D printer 18, or any combination thereof.

The imaging device 12 is intended to mean any device capable of imaging a surface and providing requisite surface data for preparing a customized repair patch. The surface data may include, but is not limited to, image data, spatial data, material data, color data, texture data, or any combination thereof. Image data includes, but is not limited to, digital or analog images of the surface to be repaired. In some implementations, the image data includes a multiplicity of digital or analog images, taken simultaneously or sequentially, from different distances, positions, or angles normal to the surface. Spatial data includes, but is not limited to, data representing objects defined a geometric space, such as line length, polygon area, or distance between object. Imaging devices for generating image data include, but are not limited to cameras or video recorders, such as digital cameras or digital video recorders. As used herein cameras or video recorders are intended to include cameras or video recorders having a single lens and single image sensor or a multiplicity of lenses and a corresponding number of image sensors, such as a stereo camera or stereo video recorder. Imaging devices for generating spatial data include, but are not limited, to echolocation devices, such as LIDAR (light detection and ranging) devices, SONAR (sound navigation and ranging) devices, or RADAR (radio detection and ranging) devices. Material data includes, but is not limited to, data representing the material properties of the damaged are, including but not limited to, composition of the damaged surface, hardness of the damaged surface, elasticity of the damaged surface, compression strength of the damaged surface, and/or tensile strength of the damaged surface.

In some implementations, the imaging device 12 may also comprise a computing device. In certain implementations, the imaging device 12 is integrated into a single device with the user device 10. Examples of this sort of implementations includes, but is not limited to, mobile computing devices, such as laptops, tablets, smart phones, and wearable computing devices (e.g., headsets and/or watches). In other implementations, the imaging device 12 and the user device 10 are separate devices. When the imaging device 12 also comprises a computing device, the imaging device 12 may execute one or more applications capable of generating spatial data from image data. Exemplary applications capable of generating spatial data from image data include photogrammetry applications. Photogrammetry applications are intended to mean applications capable of reconstructing a 3D object from two-dimensional (2D) image data, e.g. a multiplicity of digital or analog images taken simultaneously or sequentially from different distances, positions, or angles normal to the surface.

To provide for interaction with a user, the user device 10 may be in communication with a display device 14 for providing the user information regarding a 3D model of the repair patch that the user can evaluate. A display device is intended to mean any device capable of providing visual feedback, auditory feedback, tactile feedback, or any combination thereof to the user. Display devices include, but are not limited to, CRT (cathode ray tube) monitors, LCD (liquid crystal display) monitors, LED (light emitting diode) monitors, touch screens for displaying information to the user, augmented reality devices, heads up displays, or wearable computing devices (e.g., headsets, googles, eyeglasses, gloves, and/or watches). In certain implementations, the display device 14 is integrated into a single device with the user device 10. Examples of this sort of implementations includes but is not limited to, mobile computing devices, such as laptops, tablets, smart phones, and wearable computing devices (e.g., headsets and/or watches). In other implementations, the display device 14 and the user device 10 are separate devices.

In some implementations, the display device 14 may also comprise a computing device. In certain implementations, the display device 14 is integrated into a single device with the user device 10. Examples of this sort of implementations includes, but is not limited to, mobile computing devices, such as laptops, tablets, smart phones, and wearable computing devices (e.g., headsets and/or watches). In other implementations, the display device 14 and the user device 10 are separate devices. When the display device 14 also comprises a computing device, the display device 14 may execute one or more applications capable of rendering a 3D model from 3D model data and/or instructions. Exemplary applications for rendering a 3D model include, but are not limited to, graphics processing or imaging processing applications.

The backend system 16 is intended to be a computing device capable of performing one or more operations associated with the methods described herein or one or more applications associated with the methods described herein. The backend system 16 may comprise one of more applications for receiving surface data from the user device 10, generating a 3D model from the surface data received from the user device 10, transmitting the 3D generated from the surface data to the user device 10, receiving a request from the user device 10 for generating instructions for producing a repair patch corresponding to a 3D model, transmitting instructions for producing a repair patch to the user device 10, transmitting instructions to a 3D printer 18 or any combination thereof. The backend system may be implemented as a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the backend system 16 includes a cloud server or a web server. In such an implementation, the backend system 16 may run a virtualization environment that may create virtual machines. In each virtual machine, there may be an operating system or system-level environment. Each virtual machine may spawn processes, each of which may support at least one application. An execution environment such as a Java Virtual Machine or .NET™ runtime may execute in a virtual machine and manage processes and threads. In implementations utilizing a web server, the web server can run a variety of server or mid-tier applications, which those of skill in the art can select an implement.

The 3D printer 18 is intended to any device capable of producing a 3D object, such as the repair patch, by additive manufacturing or subtractive manufacturing from instructions corresponding to a 3D model for preparing a repair patch. The instructions for producing the repair patch may be received from the user device 10 and/or backend system 16. In an alternative implementation, the 3D printer comprises a computing device capable of generating instructions for producing the repair patch from the 3D model. The 3D printer may be capable of additive manufacturing or subtractive manufacturing by any suitable process or technique. Additive manufacturing techniques include, without limitation, binder jetting, directed energy deposition, material extrusion, material jetting, powder bed fusion, sheet lamination, or vat photopolymerization. Subtractive manufacturing techniques include, without limitation, controlled cutting, grinding, milling, drilling, or melting of material to achieved a desired 3D product. Various 3D printers are known, and the user can select an appropriate 3D printer for the repair patch to be produced. Optionally, an appropriate 3D printer may be suggested based on evaluation of the 3D model.

FIG. 2 is a flowchart of an exemplary method for preparing a repair patch. In certain embodiments, the method comprises imaging a damaged surface with the imaging device 102, generating a 3D model from the imaging data of the damaged surface 104, generating instructions for preparing a repair patch corresponding to the 3D model 106, and producing a repair patch from the instructions 108.

In some implementations, imaging the surface 102 may comprise photographing a damaged surface a multiplicity of times from different distances, from different positions, from different angles, or any combination thereof to generate image data. The damaged surface may be photographed a multiplicity of times, either sequentially or simultaneously. Photographing is intended to include, but is not limited to, taking making one or more digital images or analogue images of the damage surface or making a digital or analogue video recording of the damaged surface. In other implementations, imaging the surface 102 may comprise determining distances between different points on the damaged surface and/or determining distances between the imaging device 12 and the damaged surface to generate spatial data. In yet other embodiments, imaging the surface 102 may comprises determining the material properties, the texture properties, or the color properties of the damaged surface with the imaging device 12 to generate material data, texture data, or color data. Imaging the surface 102 may also comprise any combination of the forgoing.

Generating a 3D model 104 comprises processing the surface data to prepare the 3D model. Processing operations may be accomplished by the backend system 18, but may be accomplished by any other computing device, including the user device 10. After the 3D model has been generated, the 3D model can be provided to the user via the display device 14 in any suitable form for evaluation. If the display device 14 has a augmented reality device, the augmented reality device can be used to evaluate the 3D model in an augmented reality environment. This allows for the display device 14 to present the 3D model in the same environment as the damaged surface and/or overlaid onto the damaged surface. The user can confirm the repair patch model is satisfactory for 3D printing. Alternatively, the user can request an updated 3D model. The updated 3D model may be prepared from additional surface data and/or optional features selected by the user. The user may request any number of updated 3D models until the 3D model is satisfactory for 3D printing.

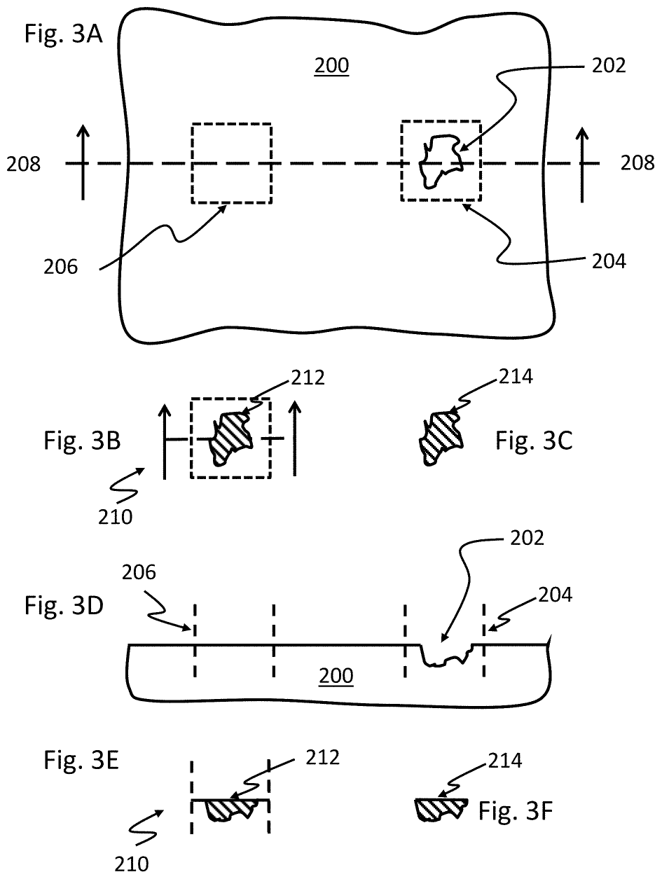

The 3D model may be generated from surface data and, optionally, one or more optional features selected by the user. When generating a 3D model, the system performs model-specific operations based on the surface data. An exemplary embodiment for generating the 3D model is illustrated in FIGS. 3A-3F. FIG. 3A illustrates a surface 200 having damage 202, such as a scratch, a crack, a dent, an indentation, a hole, or a depression, in the surface 200. FIG. 3D illustrates the surface 200 in cross-section along line 208. A damaged area, which be defined by a bounding surface indicated by the hatched line 204, can compared to a corresponding undamaged surface area, which be defined by a bounding surface indicated by the hatched line 206. In some implementations, 2D images taken of the surface are projected onto a 3D or polygon mesh or voxelized within the bounding surface. As shown in FIGS. 3B and 3E, the processing application can prepare a virtual overlay 210 of the damaged and undamaged areas by matching the bounding surfaces 204 and 206 and/or the damaged and undamaged surfaces in proximity to the bounding surfaces. This may allow for identifying a volume of difference in the surfaces defined by the meshes or voxelized volumes 212. The volume of difference 212 may be voxelized and/or the outer surface of the volume of difference 212 may be used defined by a mesh to prepare the 3D model 214. Although there is the possibility of misalignment when 2D images are used to prepare a mesh, the processing software can execute one or more sets of instructions for identifying misalignment and automatically realigning the images to prepare the mesh.

In another implementation, the user may be prompted to select with gestures or other commands what part of the scanned object is damaged. The software can help to offer suggestions as to the damaged part by creating different zones on the model for areas that are different from other areas when scanned. Once the user identifies the damage, generating the 3D model may be accomplished by flipping or reversing the normals, which generates a model of the damage versus the rest of the object.

In addition to potential misalignment, different 2D images projected onto a mesh may have been captured with slightly different lighting, causing non-matching color. The processing application may scan the borders and overlaps of 2D images and test for non-matching color. Where this is detected, the colors may be blended on the 3D model or the original 2D images changed. The colors detected may be provided back to the user to confirm the desired shade of the patch.

3D scans may be used to capture the shape of an object. In order to make a photorealistic model, the modeler may build a specular map from the data. The specular map may capture the lighting properties of the object, in particular the shininess/reflectiveness of the object. In general, pictures taken of the object can be used to extract material properties of the object for 3D printer material recommendations to the user.

The user may also opt for the incorporation of optional features selected by the user. For example, the user may have opted to add an extended edge to the model, where the top edges of the patch meet with the undamaged areas to hide any damaged seam or space or to hide the adhesive used. An exemplary edge feature comprise a plurality of irregularly spaced protrusions of variable length and variable depth that overlap and form pockets in the perimeter, holes through the perimeter, or both pockets in and holes through the perimeter. Edges of this sort are described in United States Pub. No. 2018/0066442, filed Sep. 1, 2017 entitled “Wall Repair Apparatus” to Amy Louise Frederick, the contents of which are incorporated by reference in its entirety, and may form a deckled edge or rag edge. A “deckled edge” refers to a rough edge having similar appearance and form to the rough, irregular, and uncut edge typically of paper or other fibrous products created by a deckle. A “rag edge” refers to a similarly rough, irregular edge as a deckled edge but prepared from other materials, such as synthetic polymer. The rough, deckled edge or rag edge breaks up the outline of the apparatus while also having pockets and/or holes for paint to enter when applied and allows for the seamless transition from the undamaged wall to the repair patch.

Other exemplary optional features include texture features, material features, or mounting features. A texture feature may be any surface patterning or texture. The texture feature may be selected to matched to a specified surface finish, e.g., the surface finish of an undamaged surface. The texture features can be augmented with a surface overlaid onto the model. A material feature may be any selection of material for the repair patch. In some implementations, the user may be prompted to select a material the user would like to use to create the patch. The use may also be informed of the cost associated with each material option and/or recommended adhesives for a particular material. Another exemplary optional feature is a mounting feature added to the 3D model. This feature may be requested if the user was planning to print the 3D model themselves, rather than have the application send the model for 3D printing.

Generating the 3D model, in some implementations, also includes providing image provenance and/or versioning. Metadata for image provenance may be used to track image ownership. Versioning may be used to track iterations of the model itself. As the 3D model is updated, the 3D model undergoes modifications and corrections that may be tracked by versioning data.

Once the user has indicated that the 3D model is satisfactory, the 3D model data may be captured in a one or more files. Exemplary files include containing 3D model data include, without limitation, OBJ, STL, FBX, WebGL, WEB 3D, Callada, 3DS, IGES, STEP, CAD, and VRML/X3D. Instructions for producing the repair patch may be generated from the 3D model data. Generating instructions for producing the repair patch 106 may include any suitable process for preparing instructions for a 3D printer for preparing the repair patch corresponding to the 3D model. Exemplary processes include slicing the 3D model into a series of thin slices and/or generating a G-Code file containing instructions tailored to specific 3D printers.

When the repair patch is ready for printing, the patch may printed with any suitable the 3D printer 18. The appropriate 3D printer may be selected by the user based on any number of considerations, include, but not limited to, size, cost, or the material best suited to the match the material properties of the damaged surface or based on user preference. The repair patch may be printed directly by the user or, a third-party, or the backend system by sending the instructions to a 3D printer.

For wallboard and wood repairs (wood floors, cabinets), an exemplary 3D printer may be the Mcor ARKe industrial 3D printer or any other 3D printer with similar capabilities. The 3D printer uses paper as the material in a process that inkjets color onto paper before selectively binding the sheets to build up a model, layer by layer. The resulting part resembles wood in density but looks like any other full-color print. This printer can make a wall or wood repair that does not require paint or stain because the surface finish of the patch can be printed as part of the patch. This printer accepts multiple file formats for printing: STL, OBJ, VRML, DAE, 3MF. Since wood allows for easy painting and for drilling, one skilled in the art of wall and wood repair would recognize the benefits of this material for fixing wall and wood damage. Additionally, this printer can print color and texture. So a repair can look like, for example, a red colored wall or have, for example, the pattern and color of the specific wood that is damaged, based on the scanned image and 3D model.

For metal repairs, 3D printers exemplary 3D printers include 3D printers capable of Wire+Arc Additive Manufacturing (WAAM). WAAM printers work with a variety of metals: titanium, aluminum, refractory metals such as tungsten and molybdenum, invar, nickel alloys, steel, bronze, copper, and magnesium.

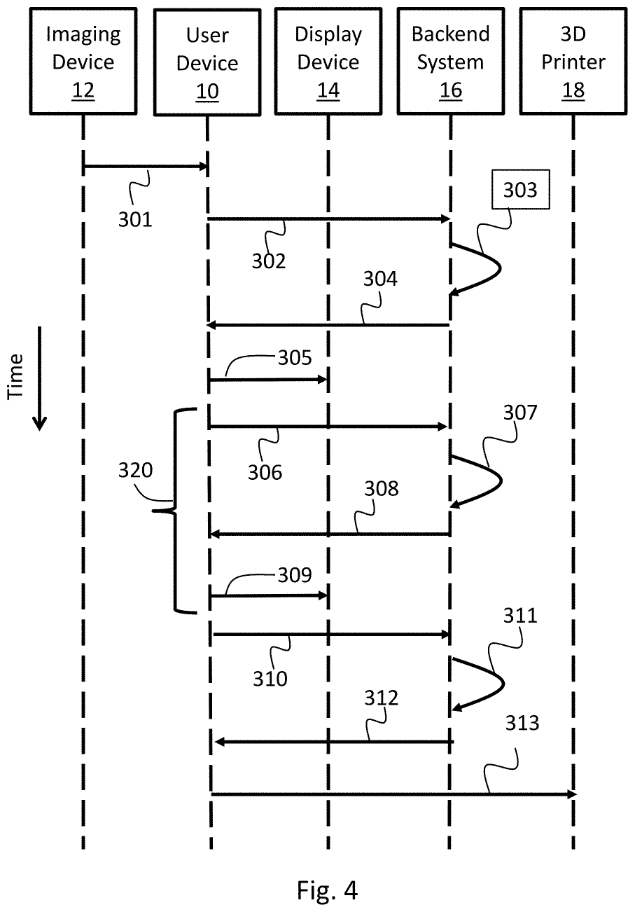

FIG. 4 is a diagram illustrating example operations performed by the system for the preparation of customized wall and surface repair patches. The vertical y-axis indicates that time is increasing from top to bottom. At time 301, surface data captured of by the imaging device 12 of the damaged surface and/or a corresponding undamaged surface may be transmitted by the imaging device 12 and received by the user device 12. The user device may request user input, including, but not limited to, user preferences, option features to be incorporated into a 3D model, or material properties. At time 302, the surface data captured by the imaging device 12 and any user input is transmitted by the user device 12 and received by the backend system 16. At time 303, the backend system 16 executes one or more applications or sets of instructions for generating a 3D model from the surface data and/or the user input. At time 304, the 3D model is transmitted by the backend system 16 and received by user device 10. At time 305, the 3D model is transmitted by the user device 10 and received by the display device 14. The display device 14 may provide the user information regarding the 3D model for evaluation, including allowing the user to view or manipulate the 3D model.

FIG. 4 also illustrates optional operations for updating the 3D model performed by the system. The optional update operations, collectively 320, include the following: The user device may request user input, including, but not limited to, user preferences, option features to be incorporated into a 3D model, or material properties. At time 306, the surface data captured by the imaging device 12 and any user input is transmitted by the user device 12 and received by the backend system. At time 307, the backend system 16 executes one or more applications or sets of instructions for generating a 3D model from the surface data and/or the user input. At time 308, the 3D model is transmitted by the backend system 16 and received by user device 10. At time 309, the 3D model is transmitted by the user device 10 and received by the display device 14. The display device 14 may provide the user information regarding the 3D model for evaluation, including allowing the user to view or manipulate the 3D model. The optional update operations 320 may be performed as many times as necessary until the 3D model is satisfactory for production.

In implementations where operations for updating the 3D model are not performed or subsequent to user input indicating that the 3D model is satisfactory, the system performs operations for generating instructions for producing a repair patch corresponding to the 3D model. At time 310, user input indicating that the 3D model is satisfactory for producing the repair patch is transmitted by the user device 10 and received by the backend system 16. At time 311, the backend system 16 executes one or more applications or sets of instructions for generating instructions for producing the repair patch corresponding to the 3D model. In implementations where the user device 10 is in communication with the 3D printer 18, the instructions for producing the repair patch may be transmitted by the backend system 16 to the user device 10 at time 312, and the instructions may be transmitted by the user device 10 and received by the 3D printer 18 at time 313 so that the repair patch can be produced. In another implementation which is not illustrated in FIG. 4, the instructions for producing the repair patch may be transmitted by the backend system 16 and received by the 3D printer 18 so that the repair patch can be produced.

In some implementations, the user device 10 executes an application for coordinating communication between the components of the system. The application may expose its functionality to web services for a remote backend system 16 or other entities via an application programming interface (API). Specifically, the API exposes at least three blocks of functionality: security APIs, model manipulation APIs, and rendering APIs.

Security APIs provide authentication for a user seeking access data. Accounts may be registered or deregistered via a registerUser( ) API. Calling this API creates, updates, or deletes data in the account data store. A session may be initiated via the login( ) API and that session terminated via the logout( ) API If the logout( ) API is not called after a predetermined time, the app will terminate the session.

Model manipulation APIs provide functions to add, remove, and update data to models, as well as to receive models. Specifically, the model manipulation APIs include addModelData( ), which allows the uploading of data to a model; and updateModelData( ), which allows the updating of data already in a model. Model data may be retrieved in GL library form via getModelData( ). Received data may include virtual object data such as objects, shades, and textures. Received data may also include product data such as points of interest. Yet other received data may also include potentially third party data.

In the event a client is determined not to support the GL library, the getNoGL( ) function may be called to use non-GL virtual data.

Rendering APIs provide functions to render data to a known quality of service. The nbtStatus( ) method allows a programmer to perform a performance check. (NBT stands for Next Best Thing.) Calling renderNBT( ) renders the next best level of quality available to a backend system.

As an illustration of the content service cycle for producing a customized repair patch, the user may provide data to the backend system 16 via the user device 10. The data may be tracked by user device software such as a viewer, or by other tracking software local to user device. The user device may be connected to a web service over a network. The backend system may send any input corresponding to the data needed to create a 3D model to an application. In some implementations, the backend system may run an application that accesses a data store via one or more API calls to see if the user has any models or surface data stored. It the service call is not authenticated, the process may then create a session using Security APIs.

If the web service call is authenticated, then the process may continue by calling one or more APIs to retrieve the 3D model data and/or surface data from a user device. The application may then run queries to retrieve the requested D model data and/or surface data from the data stores. The application may send one or more 3D model or surface data files directly back to the user device using the web service. Another possibility is showing the users the model in the application by utilizing a 3D server such as Autodesk's VRED.

The application serves the retrieved data either to the web service for forwarding to the end user, or potentially directly back to the end user's client side device for rendering via a rendering device.

The user may also execute one or more user applications on the user device. The user application may provide augmentations to be rendered along with the file to the rendering devices or rendering server. The augmentations may include color swatches, visual textures, materials, edges, and additional product information. The augmentation may be provided in the form of an augmentation data file to the rendering devices or to the rendering server. The points of interest may be selectable features that are overlaid onto a 3D product representation. The selectable features may further explain or highlight specific features of the product. For example, when a user selects a particular point of interest, additional details regarding a specific feature may be rendered or displayed as part of the 3D product representation.

The color options (color, exposure, temperature, and so on) may be rendered as a part of the 3D product representation. The color options may serve to provide additional adjustments to the patch repair model. Likewise, the visual textures may be rendered as a part of the 3D model representation. The visual textures may serve to provide additional visual options for the product that may appeal to the user. For example, textures may be aspects of the undamaged areas that are selected and rendered for different aspects of the 3D product representation.

Additional product information may be rendered with the 3D model representation to inform the user. In various embodiments, the additional information that is provided by the application may be customized to the user. For example, the additional product information may include language translation that displays the other language according to the geographical region from which the user is viewing the representation. The geographical region may be determined via a global position system (GPS) locator, an IP address of the rendering devices, language selection by the user, and/or other technologies. The additional product information may also be localized to meet governmental regulations and standards. For example, the additional product information may include health warnings, manufacturing information, usage information, adhesive recommendations, or other appropriate labeling data. Taking the example one step further, a cancer warning may be provided to a user in CA but not in NJ because of differences in each state's regulations on what is a cancer-causing material. Other product information that may be rendered with the 3D model representation may include material reviews, product ratings, and related products.

The application may provide iconography for rendering with the 3D product representation to the rendering devices or to a rendering server. The iconography may be provided based on user activity, and can be provided in the form of an iconography file that can be rendered along with the 3D product representation. The iconography data may be stored in the iconography database. For example, the application may be aware that the user has looked at the 3D patch model several times in the past or has placed the 3D patch in a virtual holding place. Accordingly, the application may provide iconography in the form of a virtual buy button that is to be displayed with the 3D product representation. In some instances, the virtual buy button may be accompanied by a discount offer to further encourage the user to make the purchase.

The application may command shaders on the rendering devices or rendering server to modify presentation of the image data based on environmental input. Shaders may adjust the image data with occlusions, reflections, refractions, and/or other visual effects. Such modification may enable the rendering device or rendering server to present the 3D patch representation, damaged item, and environmental data in an enhanced virtual reality or an augmented reality.

Input devices such as cameras, scanners, and mobile phones may also detect and map the placement of objects in a real environment. The cameras may further detect lighting conditions, light source positions, light level, light temperature, and/or other lighting parameters in the real environment. Based on these inputs, the rendering devices or the rendering server may modify the image data of the product for presentation in an augmented reality that is visible through the real environment or through video recordings of the real environment, or for presentation in a virtual reality that simulates the real environment. For example, occlusion includes hiding certain surfaces of an image from view, reflection is the duplication of at least a portion of image to simulate optical effects, and refraction is the splitting of light into its constituent waves.

The rendering devices or rendering server may use the shaders to render the image data into a 3D patch repair representation, as well as render the augmentations for the 3D patch repair representation. They may render the 3D patch repair representation into a rendered augmented reality environment or a rendered virtual reality environment. In various embodiments, the rendering devices or servers may implement one or more optimizations for the rendering. In some embodiments, the shaders may be configured to skip the rendering of image data for visual surfaces that are blocked by other visual surfaces or objects in the foreground.

If the user input is not recognized by the web service as a query command, the web service may parse a non-query related user command from the user input and process the user command accordingly. For example, if the user command is a command to rotate or manipulate a rendered 3D product representation, the web service will pass the command to the rendering devices or rendering server.

The disclosed processes may facilitate a sales process. The process may comprises receiving instructions for producing a repair patch corresponding to a 3D model matched to a damaged surface. In some implementations, the instructions are received at a 3D print so that the repair may be prepared by any suitable additive or subtractive manufacturing technique. The process may also comprise receiving delivery instructions from a user so that the repair patch can be delivered by any suitable method and/or receiving payment for the production and/or delivery of the repair patch.

When a user chooses to produce the repair patch, the user may make a purchase within a user interface via the user device 10, displayed on the display device 14, or within the backend system 16 to make an online purchase. Additionally, information relating to manifest, shipping, and delivery may be sent by the user and received by the user device 10 or the backend system 16. The backend system 16 may also encapsulate logic to track user accounts, to track and fulfill sales, receive payment for the item and for other commercial activities. However, the backend system 16 may, alternatively, utilize one or more additional backend systems, suitably an e-commerce server, one or more of these purposes. To support these activities, the backend system 16 may use APIs or direct calls as appropriate to fulfill the users sales or purchase request. Data related to such transaction instruments may be stored by the backend system 16 in a database or other suitable means. The backed system 16 may optionally use a transaction engine to process the purchase transaction.

The backend system 16 may capture delivery instructions provided by the user. Subsequently, the backed system may provide to the user access to the 3D printing instructions so that they may print the patch on a 3D printer. In other implementations, the patches may be produced and delivered to the user or prepared for pick up by the user at a specified location depending on the delivery instructions provided by the user.

A computing device is intended to represent various forms of digital computers, including are not limited to, mobile computing devices, such as laptops, tablets, smart phones, and wearable computing devices (e.g., headsets and/or watches); stationary computing devices, such as desktops, workstations, servers, blade servers, or mainframes; or other appropriate computers. The components described here, their connections and relationships, and their functions, are meant to be exemplary only, and are not meant to limit implementations of the inventions described and/or claimed in this document. Computing devices includes a processor (i.e., processor), memory, a storage device, a high-speed interface/controller connecting to the memory and high-speed expansion ports, and a low speed interface/controller connecting to a low speed bus and storage device. Each of the components are interconnected using various busses and may be mounted on a common motherboard or in other manners as appropriate. The processor can process instructions for execution within the computing device, including instructions stored in the memory or on the storage device to display graphical information for a GUI on an external input/output device, such as a display device coupled to a high speed interface. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory stores information non-transitorily within the computing device. The memory may be a computer-readable medium, a volatile memory unit(s), or non-volatile memory unit(s). The non-transitory memory may be physical devices used to store programs (e.g., sequences of instructions) or data (e.g., program state information) on a temporary or permanent basis for use by the computing device. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs), phase change memory (PCM) as well as disks or tapes. Examples of volatile memory include, but are not limited to, random access memory (RAM), dynamic random access memory (DRAM),or static random access memory (SRAM).

The storage device is capable of providing mass storage for the computing device. In some implementations, the storage device is a computer-readable medium. In various different implementations, the storage device may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory, the storage device, or memory on processor.

The high speed controller manages bandwidth-intensive operations for the computing device, while the low speed controller manages lower bandwidth-intensive operations. Such allocation of duties is exemplary only. In some implementations, the high-speed controller is coupled to the memory, the display (e.g., through a graphics processor or accelerator), and to the high-speed expansion ports, which may accept various expansion cards (not shown). In some implementations, the low-speed controller is coupled to the storage device and low-speed expansion port. The low-speed expansion port, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

A computing device may use a variety of different operating systems. In examples where a computing is a mobile device, the computing device may run an operating system including, but not limited to, ANDROID® developed by Google Inc., IOS® developed by Apple Inc., or WINDOWS PHONE® developed by Microsoft Corporation. Accordingly, the operating system running on the computing device may include, but is not limited to, one of ANDROID®, IOS®, or WINDOWS PHONE®. In some examples a user device may run an operating system including, but not limited to, MICROSOFT WINDOWS® by Microsoft Corporation, MAC OS® by Apple, Inc., or Linux. The operating system may execute one or more software applications.

A software application may refer to computer software that, when executed by a computing device, causes the computing device to perform a task. In some examples, the software application may be referred to as an “application”, an “app”, or a “program”. Example software applications include, but are not limited to, web browsing applications, word processing applications, spreadsheet applications, messaging applications, media streaming applications, social networking applications, and games. In some examples, applications are installed on the computing device prior to the user purchasing the computing device. In other examples, the user may download and install applications on the computing device.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal,” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Unless otherwise specified or indicated by context, the terms “a”, “an”, and “the” mean “one or more.” For example, “a computing device” should be interpreted to mean “one or more computing device.”

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for the production of a repair patch, the method comprising:
(a) receiving surface data of a damaged surface imaged by an imaging device from a user device;
(b) generating a 3D model of a repair patch from the surface data; and
(c) transmitting the 3D model to the user device or a display device.

2. The method of claim 1 further comprising receiving optional features selected by a user and generating the 3D model of a repair patch from the surface data and the optional features selected by the user.

3. The method of claim 2, wherein the optional feature comprises an extended edge.

4. The method of claim 3, wherein the extended edge comprises a deckled edge or a rag edge.

5. The method of claim 1 further comprising generating instructions for producing the repair patch corresponding to the 3D model.

6. The method of claim 5 further comprising producing the repair patch from the instructions.

7. The method of claim 1 further comprising receiving additional surface data of the damaged surface and/or optional features selected by a user and generating an updated 3D model of the repair patch.

8. The method of claim 7 further comprising generating instructions for producing the repair patch corresponding to the updated 3D model.

9. The method of claim 8 further comprising producing the repair patch from the instructions.

10. The method of claim 1, wherein the surface data comprises image data, spatial data, material data, color data, texture data, or any combination thereof.

11. The method of claim 10, wherein the image data comprises a multiplicity of digital images, taken taking simultaneously or sequentially, from different distances, positions, or angles normal to the damaged surface.

12. A method for the production of a repair patch, the method comprising:
(a) transmitting surface data of a damage surface imaged by an imaging device;
(b) receiving a 3D model of a repair patch generated from the surface data; and
(c) transmitting, from the user device to a display device, the 3D model of the repair patch for evaluation.

13. The method of claim 12 further comprising transmitting optional features selected by a user and receiving the 3D model of a repair patch generated from the surface data and the optional features selected by the user.

14. The method of claim 13, wherein the optional feature comprises an extended edge.

15. The method of claim 14, wherein the extended edge comprises a deckled edge or a rag edge.

16. The method of claim 12 further comprising receiving instructions for producing the repair patch corresponding to the 3D model.

17. The method of claim 16 further comprising producing the repair patch from the instructions.

18. (canceled)

19. (canceled)

20. (canceled)

21. (canceled)

22. (canceled)

23. The method of claim 12, wherein the display device is an augmented reality device.

24. (canceled)

25. A method for the production of a repair patch, the method comprising:
(a) receiving instructions for producing the repair patch corresponding to a 3D model matched to a damaged surface and an optional feature selected by a user; and
(b) producing the repair patch from the instructions,
wherein the optional feature is a deckled edge or a rag edge.

26. The method of claim 25, wherein the instructions are received at a 3D printer.

27. (canceled)

28. (canceled)

29. The method of claim 25 further comprising receiving delivery instructions from a user and/or further comprising receiving payment from a user.

30. The method of claim 29 further comprising delivering the repair patch to the user.

31. (canceled)
